(19) United States
(12) Patent Application Publication
(10) Pub. No.: US 2008/0300937 A1
(43) Pub. Date: Dec. 4, 2008

(54) Event-linked social networking

(76) Inventors: Ty Allen, Alpine, UT (US); Tom Karren, Alpine, UT (US); Doug Bard, Provo, UT (US)

Correspondence Address: STETINA BRUNDA GARRED & BRUCKER, 75 ENTERPRISE, SUITE 250, ALISO VIEJO, CA, 92656, US

(21) Appl. No.: 12/074,472

(22) Filed: Mar. 4, 2008

Related U.S. Application Data
(60) Provisional application No. 60/940,917, filed on May 30, 2007.

(51) Int. Cl. G06Q 10/00

(52) U.S. Cl. 705/7; 705/1

(57) ABSTRACT

Embodiments of the invention provide increased user-to-user interaction and increase the sphere of influence event attendees have on one another by sharing what event functions and other features are being attended by persons having similar interests. Embodiments of the present invention may provide a new and enhanced end-user interface to social networking users, especially individual and business attendees of large events. Embodiments of the invention expand social networking principles to allow event attendees to influence and rely on one another in selecting courses and sessions. This may be accomplished by allowing a particular attendee to view the chosen schedules of other attendees while the particular attendee is selecting an attendance schedule before and throughout a conference or other similar event by searching for and matching user characteristics in social-networking fashion and displaying event functions selected by matching users.

### CROSS-REFERENCE TO RELATED APPLICATIONS

This application claims the benefit of U.S. Provisional Patent Application Ser. No. 60/940,917, entitled EVENT-LINKED SOCIAL NETWORKING, filed on May 30, 2007, the teachings of which are expressly incorporated by reference.

### STATEMENT RE: FEDERALLY SPONSORED RESEARCH/DEVELOPMENT

Not Applicable

### BACKGROUND

1. Field of the Invention

The present invention relates to social networking, and more particularly to improved social networking, person-to-person connections, and user-driven content at large events such as conferences.

2. Background and Related Art

Current social networking techniques allow professionals of like interests to connect and share their experiences and knowledge. These techniques and systems may suggest matches based on user profiles and other personal information and interests that are typically entered in by the user. Additionally, such techniques and systems may allow a user to interactively search for people having certain interests, areas of expertise, and other profile attributes. In this way, connections may be made between interested individuals or businesses.

Such systems and methods, however, are limited in that they typically only make and/or allow connections between individuals. Therefore, the influence of such systems is limited and fails to provide opportunities for additional interaction and influence between connected or potentially-connected individuals and other entities. The current systems and methods are also limited in that they fail to fully provide potentially-relevant information to individuals accessing the social networking systems and fail to fully utilize the information available to allow individuals to make informed decisions for networking.

Conferences and other large-scale meetings of individuals often bring together great deals of information into a single location at the same time that many individuals that may be of interest to each other are brought together. Unfortunately, it has historically been difficult to make use of the confluence of information and individuals in meaningful ways. Instead, any interaction between the information and the individuals has historically been one-directional in a lecture-type format. The interaction among individuals has also historically been on a haphazard and accidental basis with little to no overall coordination of such interactions.

### BRIEF SUMMARY OF THE INVENTION

Embodiments of the invention provide a new end-user interface and tools to conference attendees and other persons and businesses involved in potential social networking opportunities. The embodiments may provide traditional social networking features such as profile-based linking of individuals and businesses based on matches of information about the attendees and other participants at a conference. They may also provide the users with the opportunity to create and schedule meetings, formal and informal, related to any found social networking connections. The embodiments of the invention also provide increased user-to-user interaction and increase the sphere of influence event attendees have on one another and increase the information available to event attendees to improve their event experience by better understanding what event functions and other features are being attended by persons having similar interests.

Embodiments of the present invention may provide a new and enhanced end-user interface to social networking users, especially individual and business attendees of large events. At many events, especially large events such as large conferences, more meetings and break-out sessions may be offered than an individual or business representative may feasibly attend, either because the sessions may be offered in different rooms at the same time, or for any other reason, such as distance between locations of consecutive offerings. This may be especially problematic at large conferences, where multiple, even tens of, simultaneous sessions may be offered. Attendees at such conferences may be particularly limited, then, in what sessions of those offered they may attend.

Additionally, this problem presents itself to an event attendee even before the event begins, when the attendee is attempting to decide which functions are potentially interesting and desirable to attend. When wading through the numerous course and session offerings, it may often be difficult for an attendee even to get a firm grasp on the available courses and sessions that might be of particular interest to the attendee. However, embodiments of the invention, through the new end-user interface, may provide such attendees with improved understanding and knowledge of desirable course offerings and even desired selections of individual and groups of courses and sessions that may be of particular interest to the attendee by expanding social networking principles to allow attendees to influence and rely on one another in selecting courses and sessions.

This may be accomplished by allowing a particular attendee to view the chosen schedules of known and/or anonymous other users/attendees while the particular attendee is selecting an attendance schedule before and throughout a conference or other similar event. The embodiments of the invention thus allow groups of users to influence other groups of users in novel ways to improve attendees' experiences before and during such events. Thus, a user can decide what to do at an event in a more efficient fashion using embodiments of the present invention and may have a more meaningful experience at an event. Embodiments of the invention may also improve the experience of attendees at events during the event in additional ways and may provide synergistic benefits to event sponsors, exhibitors, lecturers, and organizers, as will become clear from the following description, with reference to the Figures.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a plan view of an illustrative computer system for use with embodiments of the present invention;

FIG. 2 shows a plan view of an illustrative networked computer system for use with embodiments of the present invention;

FIG. 3 shows a flowchart of a method in accordance with embodiments of the present invention;

FIG. 4 shows a flowchart of a method in accordance with embodiments of the present invention;

FIG. 5 shows a flowchart of a method in accordance with embodiments of the present invention; and

FIG. 6 shows a flowchart of a method in accordance with embodiments of the present invention.

### DETAILED DESCRIPTION

The detailed description set forth below is intended as a description of the presently preferred embodiments of the invention, and is not intended to represent the only forms in which the present invention may be constructed or utilized. It is expected that the present invention may take many other forms and shapes; hence the following disclosure is intended to be illustrative and not limiting. The description sets forth the functions and sequences of steps for constructing and operating the invention. It is to be understood, however, that the same or equivalent functions and sequences may be accomplished by different embodiments and that they are also intended to be encompassed within the scope of the invention.

Embodiments of the invention provide a new end-user interface and tools to conference attendees and other persons and businesses involved in potential social networking opportunities. The embodiments may provide traditional social networking features such as profile-based linking of individuals and businesses based on matches of information about the attendees and other participants at a conference. They may also provide the users with the opportunity to create and schedule meetings, formal and informal, related to any found social networking connections. The embodiments of the invention also provide increased user-to-user interaction and increase the sphere of influence conference attendees have on one another and increase the information available to conference attendees to improve their conference experience by better understanding what conference sessions and other features are being attended by persons having similar interests.

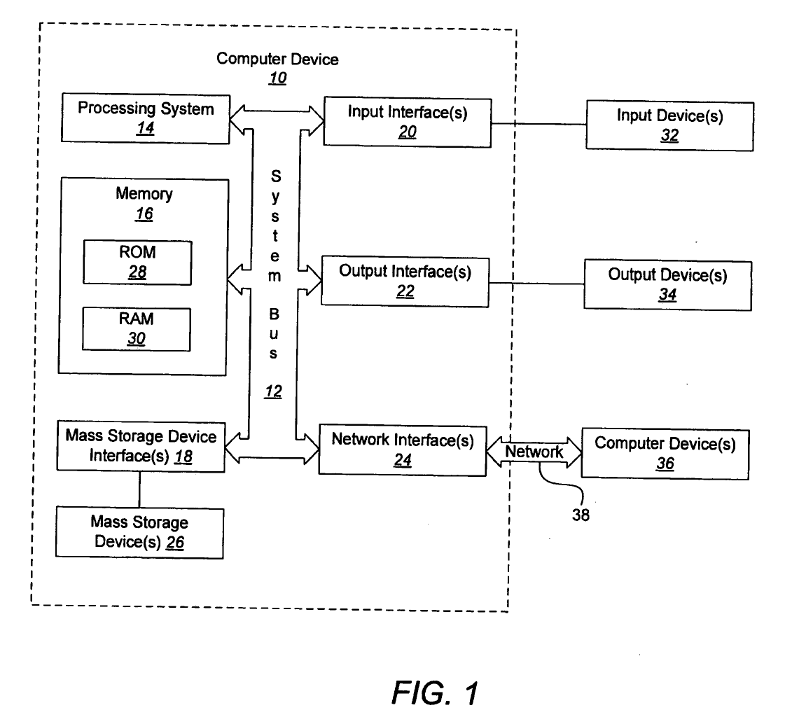

As at lease some embodiments of the invention embrace the user of computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (RAM), read-only memory (ROM), programmable read-only memory (PROM), erasable programmable read-only memory (EPROM), electrically erasable programmable read-only memory (EEPROM), compact disk read-only memory (CD-ROM), or any other device or component that is capable of providing data or executable instructions that may be accessed by a processing system.

With reference to FIG. 1, a representative system for implementing embodiments of the invention includes computer device 10, which may be a general-purpose or special-purpose computer. For example, computer device 10 may be a personal computer, a notebook computer, a personal digital assistant (PDA) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components.

System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (BIOS) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (USB), an integrated circuit, a FireWire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (LAN) or a modem, wireless link, or other adapter for connection to a wide area network (WAN), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

Those skilled in the art will appreciate that embodiments of the present invention embrace a variety of different system configurations. For example, in one embodiment the system configuration includes an output device (e.g., a multifunctional peripheral (MFP) or other printer/plotter, a copy machine, a facsimile machine, a monitor, etc.) that performs multi-colorant rendering. In another embodiment, the system configuration includes one or more client computer devices, optionally one or more server computer devices, and a connection or network communication that enables the exchange of communication to an output device, which is configured to perform multi-colorant rendering.

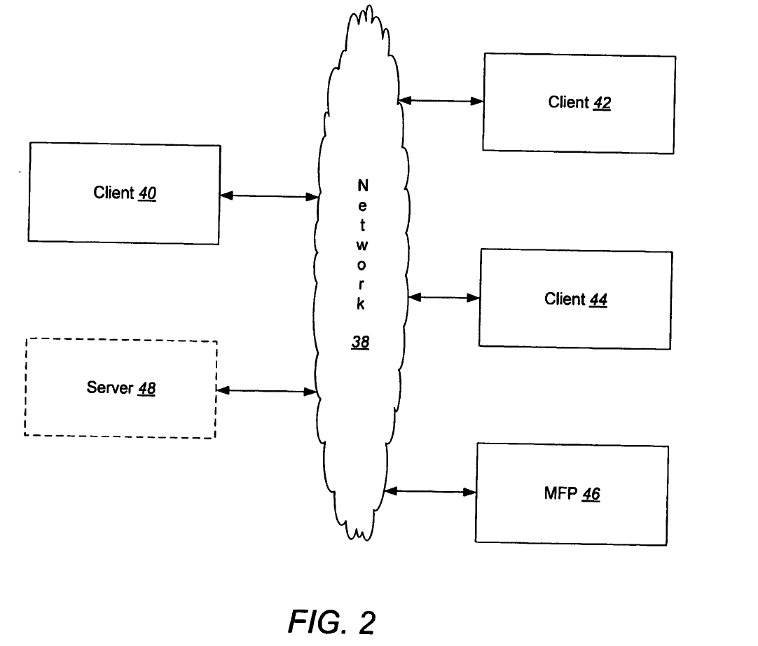

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Embodiments of the present invention may provide a new and enhanced end-user interface to social networking users, especially individual and business attendees of large conferences. At many conferences, especially large conferences, more meetings and break-out sessions may be offered than an individual or business representative may feasibly attend, either because the sessions may be offered in different rooms at the same time, or for any other reasons, such as distance between locations of consecutive offerings. This may be especially problematic at large conferences, where multiple, even tens of, simultaneous sessions may be offered. Attendees at such conferences may be particularly limited, then, in what sessions of those offered they may attend.

Additionally, this problem presents itself to a conference attendee even before the conference begins, when the attendee is attempting to decide which sessions are potentially interesting and desirable to attend. When wading through the numerous course and session offerings, it may often be difficult for an attendee even to get a firm grasp on the available courses and sessions that might be of particular interest to the attendee. However, embodiments of the invention, through the new end-user interface, may provide such attendees with improved understanding and knowledge of desirable course offerings and even desired selections of individual and groups of courses and sessions that may be of particular interest to the attendee by expanding social networking principles to allow attendees to influence and rely on one another in selecting courses and sessions.

This may be accomplished by allowing a particular attendee to view the chosen schedules of known and/or anonymous other users/attendees while the particular attendee is selecting an attendance schedule before and throughout a conference or other similar event. The embodiments of the invention thus allow groups of users to influence other groups of users in novel ways to improve attendees' experience before and during such events. Thus, a user can decide what to do at an event in a more efficient fashion using embodiments of the present invention and may have a more meaningful experience at an event. Embodiments of the invention may also improve the experience of attendees at events during the event in additional ways, as will become clear from the following description.

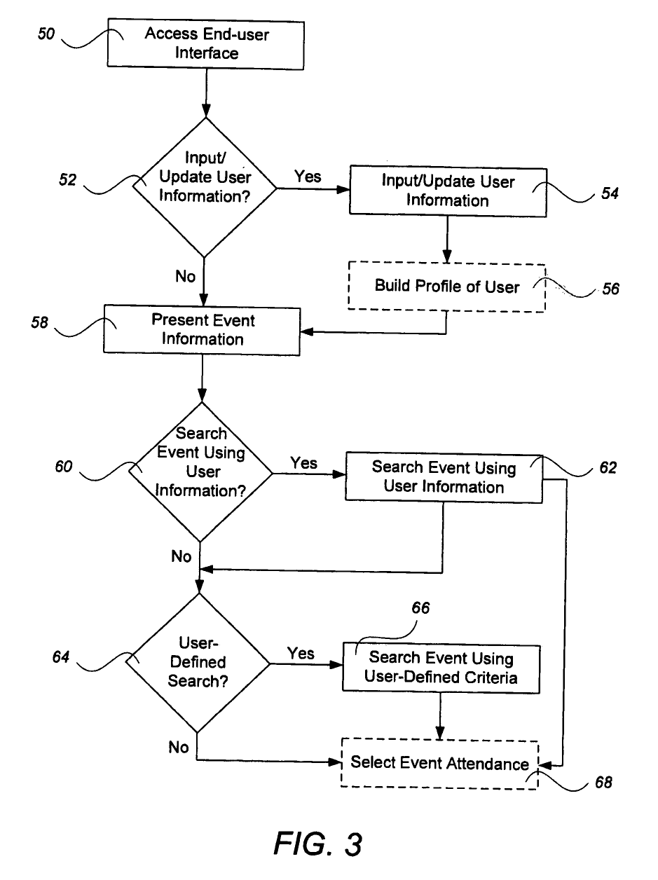

FIG. 3 shows a flowchart representing a method in accordance with one embodiment of the present invention. In the illustrated method, a user accesses an end-user interface at step 50. The end-user interface may be provided via a web application on an Internet connection (whether hard-wired or wireless) to all attendees or potential attendees of an event, such as a conference. Alternatively, the end-user interface may be provided as a computer program distributed on a computer-readable medium to attendees prior to an event or may be provided on computer terminals and/or via a local network at an event or at a building hosting an event. Any method of presenting the end-user interface to an attendee before or during an event is embraced by the embodiments of the invention. In some embodiments, access to the end-user interface may be protected by a password, keycard, or other protection mechanism to limit access to certain attendees or potential attendees, and in other embodiments access may be unrestricted.

After the user accesses the end-user interface, the user may be presented with an opportunity to input or update the user's personal information and/or preferences at decision block 52. If the user selects to enter and/or update the user's personal information, the user may be presented with selected prompts and or questions to assist the user in providing and inputting relevant information at step 54. By way of example, and not limitation, the interface may present a series of prompts and/or questions to the user with various pre-selected and/or free-form answers available to the prompts and/or questions. This information may permit embodiments of the invention to build a social-networking-type profile of the user at step 56 for use in providing desirable information to the user and to additional users/attendees, as described in more detail below. In addition, the user may be presented with the opportunity to make the user-entered information partially or wholly anonymous and partially or wholly available to other users of the end-user interface. The user may also make the user's information selectively anonymous and selectively available to certain selected other users of the end-user interface. In this way, the user may select the extent to which the user's information may be used by the systems and methods of the present invention to influence other attendees of the event.

After the user has entered in the user information at step 54 or opts not to input or update such information, the user may be presented with event information, which may include a schedule of sessions and courses or any other relevant information at step 58. As set forth above, however, some users may find such information daunting to digest and understand, and may be unwilling or unable to sort through all the potentially-available information to decide what information is of particular interest or relevant to the users. Therefore, the end-user interface may provide the user with an option to search the event information to determine what sessions, meetings, courses, and the like, other attendees of the event are attending.

For example, as illustrated in FIG. 3, the user may be presented with an opportunity to search the event information at decision block 60, using any user information the user has previously inputted. If the user selects to search the event information according to the user information, the event information is searched at step 62. Additionally or alternatively, the user may be presented with an opportunity to search the event information at decision block 64, using user-defined criteria, the user-defined criteria search may be performed at step 66. Regardless of the manner used to search the event information, the user may be presented with search results as discussed below. Additionally, the user may be provided with an optional opportunity to select event attendance at step 68, in embodiments of the invention where recordation of planned event attendance is desired.

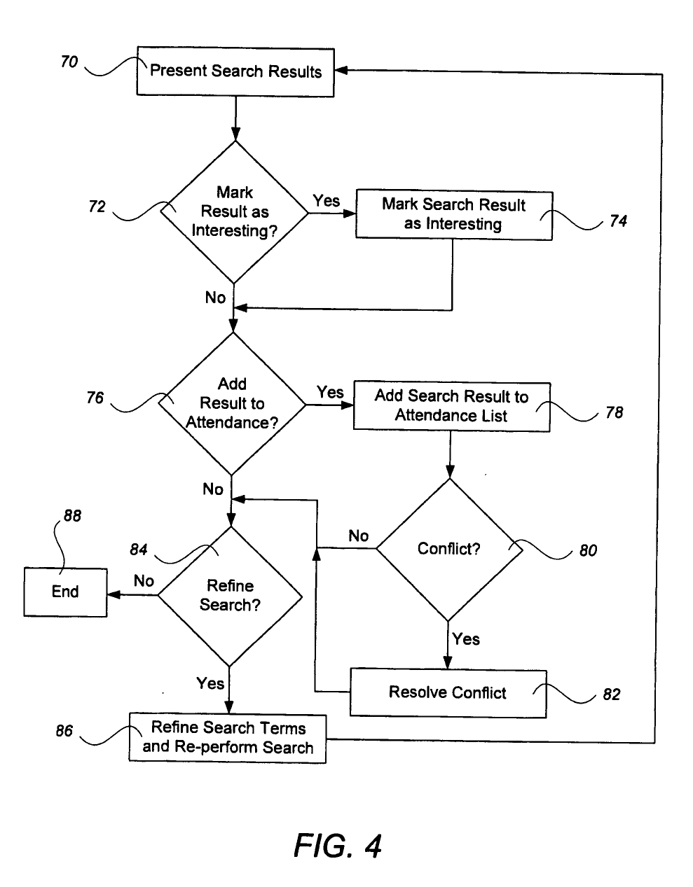

FIG. 4 shows additional details regarding the searches that may be performed in accordance with embodiments of the present invention, the results that may be returned as part of such searches, and the potential selection of event attendance by the user. In embodiments of the invention, when the event information is searched according to the user information or the user-defined criteria at either or both of steps 62 and 66, the user may be presented with search results at step 70. The search results of the present invention are novel in that they present different information than has previously been available about event sessions, meetings, courses, etc. Rather than present results showing, for example, sessions related to X topic (although in some embodiments of the invention such a search may be made and such results returned), the embodiments of the invention utilize the user information and/or the user-defined criteria to show social-networking type results.

By way of one illustrative example, the returned results may be in a format similar to the following, where a search has been performed based on the user information: “Event attendees having interests similar to yours have selected to attend the following sessions:” with a listing of frequently-selected individual sessions or groups of sessions. By way of example, and not limitation, the end-user interface may provide a listing of a certain number of most-frequently-selected individual sessions, meetings, etc. and/or a certain number of most-frequently-selected groups of sessions. By way of another illustrative example, the returned results may be in a format similar to the following, where a search has been performed based on user-selected criteria: “Event attendees having the profession you selected have most frequently expressed interest in attending the following sessions:” with a list of frequently-selected sessions or groups of sessions.

In this manner and other similar manners, results may be presented to a user that may be used to guide the user in selecting meetings, sessions, courses, etc. that may appeal to the user. The search or searches may be based on social networking principles to search for those meetings, sessions, courses, etc. found to be of interest or selected by similar-minded individuals. By way of example, and not limitation, the user information and/or user-defined criteria used by the methods and systems of the embodiments of the present invention to present event information to a user may be selected from the following information: 1) professions, 2) professional specialties, 3) hobbies, 4) professional responsibilities, 5) job descriptions, 6) topics of interest, 7) lecturers of interest, 8) geographic location of work or residence, 9) preferences of selected named individuals, 10) ages, 11) genders, 12) affiliations, 13) nationalities, 14) certifications, 15) practice areas, 16) experience level, 17) named friends, associates, etc., 18) employers, 19) size of employers/businesses, 20) academic major, and 21) any other information that may be of particular relevance for a particular event.

The information searched for may be used in conjunction with any personal information received at step 52 to customize and improve the returned search results not only for a particular user, but also for any following users, as follows. When a user enters in the user's information at step 52, and/or enters in search information at step 60 and subsequently selects to attend certain event functions or marks certain event functions as being of interest, systems in accordance with the embodiments of the invention may save and associate the user information or search information in conjunction with the selected or marked event functions. Then, when subsequent users utilize the end-user interface to view event information, search for relevant event functions, and select event functions for attendance or mark event functions as relevant, the search results of the subsequent users will be improved by the addition of the information of any previous users. In this manner, a social-network-type sphere of influence may allow one user to influence others in their selection of event functions to attend.

As set forth above, in some embodiments, the users may select to make their user information and/or event function selections anonymously, partially anonymously, or open to various degrees. This may allow for searching for the preferences and/or selected event functions of specified named individuals. By way of example, and not limitation, suppose an important or famous individual is attending an event and selects to attend certain event functions. Other attendees may want to attend some or all of the same functions, either because they want the opportunity to interact with the individual or because they have determined that they will likely be interested in the same functions that the person selected. The other attendees may perform a search for sessions selected by that individual and may then choose to attend some or all of the same functions.

By way of another example, suppose Employee A of a company has researched functions at an event and has decided to attend certain functions. Employee A may choose to make his or her selections generally anonymous to most users. However, Employee A may choose to make his or her selections available to certain named persons of whom he or she is aware, such as Employees B, C, and D at Employee A's company, as well as Friends E, F, and G who will be attending the event but are not affiliated with Employee A's company. Employee A may permit those persons to perform a search on Employee A's selections by any selected method, such as by providing those persons with a password for a search, by designating certain individuals as allowed to view Employee A's selections, or by designating characteristics of searchers who will be allowed to view Employee A's selections, (such as those attending the event from Company H). Employee A's selections may or may not also be used anonymously for searches performed by other users, and in some embodiments the selection of whether Employee A's information may be so used anonymously may be selected by Employee A.

In some embodiments, when a search is performed, a user may select to emphasize or may order the relevance and/or importance of search criteria to improve the quality of the results returned at step 70. In such a fashion, the results returned may be ranked in a hierarchical fashion or may be sorted in various modes to be of most use to the user. In some embodiments, the user may select to view the results in various fashions to emphasize or de-emphasize certain search criteria and results. The results may be based on matching of the information provided by the user at step 54 and/or the user defined criteria provided at step 66 with similar information and criteria provided by other users who have selected to attend event functions or have marked event functions as being of interest.

Regardless of the information used to perform a search and to match results, the user may be provided with an opportunity to mark certain results (sessions, functions, meetings, courses, etc., or groups thereof) as being of interest to the user at decision block 72. If the user selects to mark results as being of interest and marks certain results as being interesting at step 74, those results may be saved by embodiments of the invention for future retrieval and use of the user without requiring the user to re-perform the selected search. Additionally, the user may be provided with an opportunity to select certain results (individual sessions, functions, meetings, courses, etc. as well as groups of such) for planned attendance by the user at decision block 76. If the user selects results to attend, the results may be added to the user's attendance schedule at step 78. As set forth above, the marking of search results as being of interest at step 74 or the adding of search results for attendance at step 78 may be used by embodiments of the invention in subsequent searches by other users to improve the quality of the results. Any other functions selected as being of interest or selected for attendance may be similarly used, even if not originally retrieved by a social-networking type search as described herein.

In some instances, the addition of a function to a user's attendance schedule may create a conflict with a previous entry, or may create some other conflict, such as overbooking a particular function. Therefore, in some embodiments, the addition of a function or functions to a user's schedule may be checked for a conflict at decision block 80. If a conflict is detected, execution may then proceed to step 82, where the conflict is resolved. This may mean that the user may be prompted to modify his or her schedule, may be notified of the conflict, and/or may be prompted to add his or her name to a wait list of attendees of the function in the case where the function is overbooked. Any other method of resolving the conflict is also embraced by the embodiments of the invention.

If no conflict is found or after the conflict is resolved, or after all desired results have been marked as interesting or have been added to the user's schedule, the user may be presented with a chance to refine his or her search at decision block 84. If the user wishes to continue searching with different search parameters, the user may enter new search parameters and re-perform a search at step 86, after which the results are displayed to the user at step 70 and the process repeats. If not, the process may end at step 88.

The embodiments of the invention may also be used in several additional ways to provide benefits for all interested parties. Event planners may utilize the information received to gauge interest in certain functions of the event and may change scheduling and/or location based on expressed interest. The social-networking methods described herein may also be used to recommend exhibits to users that may be of interest in addition to functions at the event. Additionally, the methods and systems of embodiments of the present invention may be used to provide updates to users so that as more users make their selections an earlier user may be notified of changing interests expressed by later users so as to give the earlier users an opportunity to revise their selected event functions. In some embodiments, users may self-generate certain types of functions, such as informal meetings and birds-of-a-feather sessions and may invite others of similar interests to join in their self-generated functions.

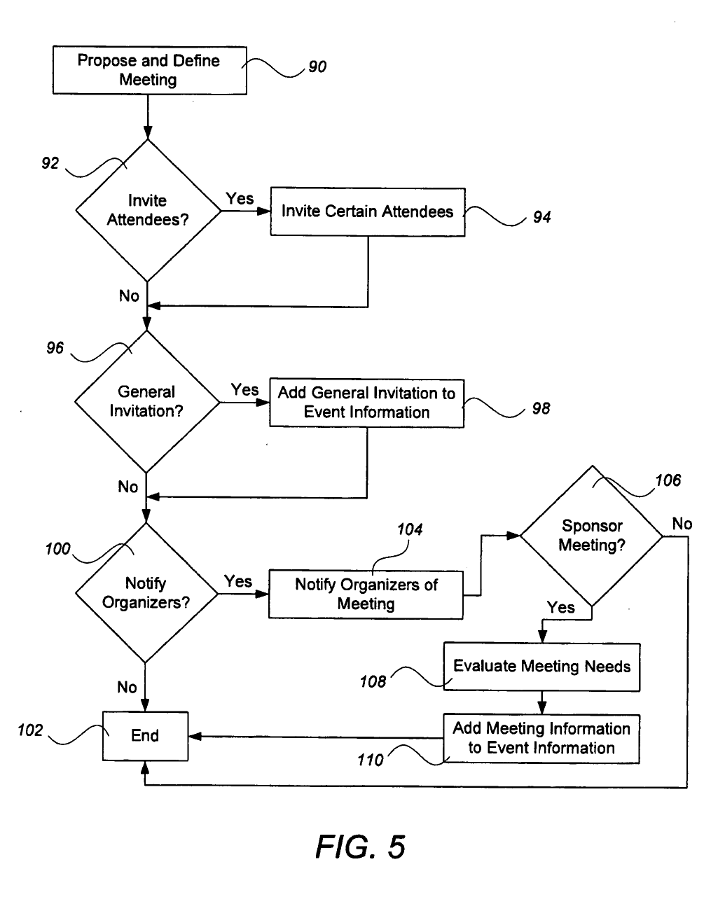

One example of a process for an end-user generating content for a meeting or conference in accordance with embodiments of the present invention is illustrated with reference to FIG. 5. The user may access an end-user interface as described above. The user may then propose and define a meeting at step 90 at any point before or during a conference or event. In proposing and defining the meeting, the user may define the scope of the meeting, the content of the meeting, a potential location, etc. For example, the user may propose and define a birds-of-a-feather session to discuss aspects of other sessions presented at a conference. Alternatively, the user might propose a dinner gathering for certain event attendees. In embodiments of the invention, the user may propose and define any type of meeting.

After the user proposes and defines the meeting at step 90, execution proceeds to decision block 92, where the user may decide to invite particular event attendees or potential event attendees to participate in and/or attend the proposed and defined meeting. If the user elects to invite particular event attendees or potential event attendees, an invitation may be generated and delivered at step 94. The invitation may be delivered by e-mail, or it may be delivered as an alert to other users accessing the end-user interface. In some embodiments, the user may be permitted to extend a general invitation to all event attendees (and potential attendees) at decision block 96. If so, a general invitation may be generated and delivered at step 98 in manners similar to those discussed above, as well as by posting on an event web page, discussion board, or physically posted at an event.

In some embodiments of the invention, when a user generates a meeting, event organizers may automatically be notified so as to better understand event attendees' interests and social connections, as well as to provide event organizers with an opportunity to sponsor the meeting. This may also be important, for example, when event organizers must schedule space for a proposed meeting to take place. In other embodiments, event organizers may not be notified of user-generated meetings without user permission. In some embodiments, a user may also be given the choice to notify event organizers of the proposed user-defined meeting at decision block 100. If the user does not select to notify event organizers, execution may end at step 102. Otherwise, event organizers may be notified of the meeting, its purpose, and the invitees at step 104.

When event organizers are notified of a meeting, they may elect to officially sponsor the meeting as a part of the event or conference at decision block 106. If event organizers decide to sponsor a user-generated meeting, the event organizers may evaluate the needs of the meeting, such as event space, the meeting time, audiovisual needs, food requirements, etc. at step 108 and may add the meeting information to the event information at step 110 so that the meeting may become available to all event attendees and potential event attendees. In this way, the user-generated content may become official event information and official event content of the type discussed above with respect to FIGS. 3 and 4.

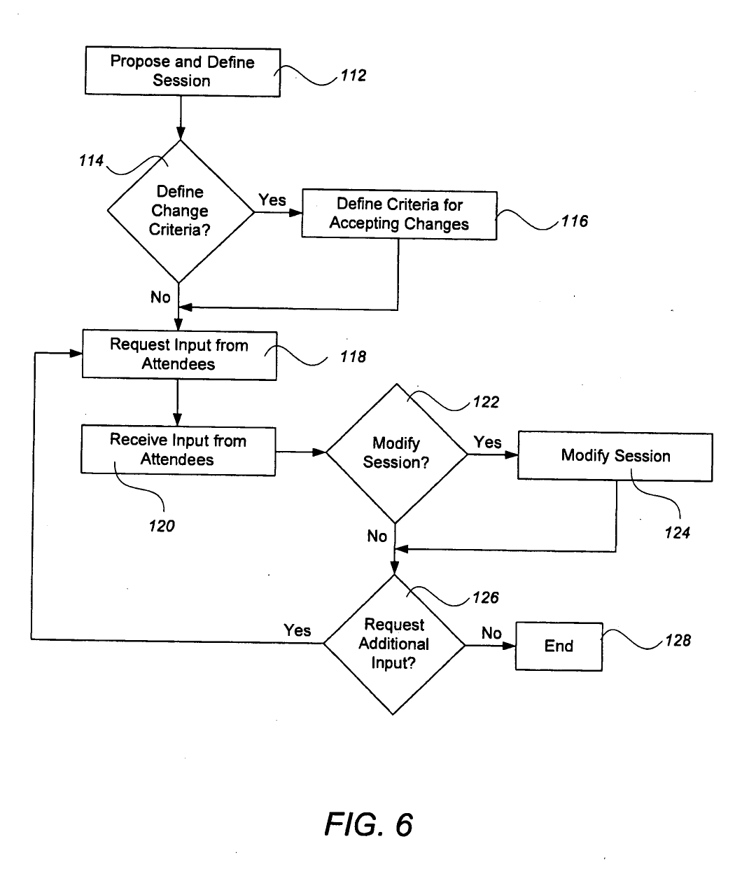

Another example of a process whereby someone other than an event organizer may generate event content is illustrated in FIG. 6. By way of the illustrated process, a session lecturer may solicit topic requests and information from event attendees and may modify his or her lecture to accord with the interests of attendees. In this way, a lecture may be modified to better suit the needs and interests of event attendees. The lecturer may access a user interface as previously discussed. In some embodiments, the user interface may be modified for lecturer access. The lecturer may then propose and/or define a session or any aspects of the session at step 112. For example, in some embodiments, the lecturer may already have agreed to present information on a certain topic for a certain length of time and may further define those areas on which the lecturer plans to speak at step 112. In other embodiments, the lecturer may only have agreed to speak and may leave the topic for discussion completely open-ended.

Regardless of how defined the session topic is, the lecturer may be presented with an option to define criteria under which the topic, session, etc. of the lecturer will be changed at decision block 114. If the lecturer decides to define change criteria, he or she may do so at step 116 and may define any criteria for change desired. For example, the lecturer may request comments from attendees and may define the change criteria such that no changes take place without the lecturer actually making the changes. As another example, the lecturer may submit an outline and may permit users to change and modify the outline of topic discussion without requiring that the lecturer specifically accept changes. Any level of criteria for changes may be used and fall within the scope of the invention.

Whether the lecturer defines change criteria or not, the lecturer may request input from attendees and potential attendees at step 118. Based upon any responses received in step 120, a decision may be made whether to modify the session at decision block 122. The decision to modify the session may be made by the lecturer, by voting of event attendees, automatically according to any defined change criteria, by event organizers, or by any other method. If session modification is desired, the session may be modified at step 124, and a decision may be made whether to request and/or accept additional input from attendees at decision block 126. If additional input is desired, execution returns to step 118. Otherwise, execution ends at 128.

In the above-illustrated manners and other methods and processes made possible by embodiments of the invention, aspects of social networking may be used to shape conferences and events in ways not previously available. The embodiments of the invention provide for synergistic effects based on increased interaction between all event participants, from organizers to attendees and from lecturers and speakers to exhibitors. These synergistic effects extend from before an event throughout the event and may continue beyond the end of an event. The embodiments of the invention permit the participants to interactively create event content virtually and to pass the virtual event content into actual event content where it may be enjoyed by the event participants.

In additional aspects of the invention, the social-network-type user information may continue to be used throughout the various functions of an event. By way of example, many attendees of an event now have access to smart devices such as smart phones and Internet-connected devices such as PDAs and portable computer devices. An event may use such devices or may use a proprietary device distributed at an event to distribute advertisements of sponsors, of event functions and to distribute other contextual information relevant to an event to attendees while they are attending the event. Such distribution of information may be targeted based on the user preferences previously entered and/or may be targeted based on the sessions being attended by event attendees. In some embodiments, information may be distributed based on an attendee's specific attendance at a function, based on confirming that the attendee actually attended or is in attendance at the function, such as by swiping a user-identifying pass card upon entering, or using near-field communication such as radio-frequency identification (RFID) to identify attendees as they enter and/or leave a session. Similar techniques may be used to track viewing of event exhibits and may be used to push specific advertisements or communications of thanks for visiting a function or an exhibit. In this way, it may be seen that the embodiments of the invention may be used in many ways to improve the experience of attendees at an event and to provide benefits to advertisers, sponsors, and organizers of an event.

In addition, in some embodiments of the invention, the information provided by users may be utilized to enhance social networking at the event. For example, an event sponsor might distribute a device to all event attendees as indicated earlier. Then whenever two devices belonging to individuals with similar interests are in close proximity, they may notify the attendees of the fact so as to permit the users to network socially. Such devices, as well as user-owned devices such as smart phones or portable computer devices, may also be used to receive audience responses during presentations to permit improved interactivity during event functions. Therefore, event attendees may receive a device or an identification card that may be used in conjunction with embodiments of the invention to provide additional benefits to event attendees as well as organizers, sponsors, and exhibitors, as will be set forth below.

An exhibitor or sponsor may utilize embodiments of the invention to interact with event attendees and event organizers in new ways. Before or during an event, for example, an exhibitor or sponsor may access an end-user interface similar to or identical to those discussed above or may access a special end-user interface available only to exhibitors and sponsors. The exhibitor or sponsor may search event information and attendee information in a fashion similar to those previously discussed, and the exhibitor or sponsor may be provided with additional information about attendees in some embodiments than is provided to other attendees. From this information, the exhibitor or sponsor may create a watch list that is based on social networking principles for event attendees of people with whom the exhibitor or sponsor is interested in further interaction and influence. For example the exhibitor or sponsor may view and select individual event attendees to add to the watch list or the exhibitor or sponsor may elect to add all event attendees who attend a particular course, session, meeting, etc. to the exhibitor's watch list. In this way, an exhibitor or sponsor may even modify and update the watch list as the event proceeds, such as by an exhibitor representative who attends a relevant session or who encounters an interesting individual adding the attendees of the session or the interesting individual to the exhibitor's watch list.

The watch list may be used by exhibitors and sponsors to create social networking and business opportunities. Embodiments of the invention permit exhibitors and sponsors to create meetings such as special sessions or dinners and to invite persons on the watch list to attend the created meetings. Additionally, if users have had user devices distributed to them as discussed above or have identification cards with near-field communications capabilities such as RFID, an exhibitor may elect to be notified whenever a person on the exhibitor's watch list approaches the exhibitor's area. The notification may be provided through an exhibitor device such as an exhibitor lead retrieval device, and the notification may provide information about the individual for recollection by the exhibitor. In this way, the exhibitor may receive special and helpful notification when potentially important individuals are near to the exhibitor for potential interaction, social networking opportunities, and business opportunities.

Therefore, although the embodiments of the invention have been primarily intended to benefit the event experience of attendees and potential attendees, the embodiments of the invention have been found to provide benefits to event organizers, sponsors, lecturers and speakers, and exhibitors as the production back-end has been tied to the social networking front end of the event experience.

The present invention may be embodied in other specific forms without departing from its spirit or essential characteristics. The described embodiments are to be considered in all respects only as illustrative and not restrictive. The scope of the invention, is, therefore indicated by the appended claims, rather than by the foregoing description. All changes which come within the meaning and range of equivalency of the claims are to be embraced within their scope.

What is claimed is:

1. A method for using user information to provide suggested event functions to a user based on event functions selected by other event attendees, comprising:
providing an event having a plurality of event functions that may be attended by a user;
receiving information from a plurality of event attendees about the plurality of event attendees;
receiving a plurality of selections of event functions from the plurality of event attendees;
receiving information from the user about the user;
comparing the information about the plurality of event attendees with the information about the user;
selecting one or more of the plurality of event attendees as having information matching the information about the user; and
suggesting event functions to the user, the event functions being selected from those selections of event functions from the one or more of the plurality of event attendees having information matching the information about the user.

2. The method of claim 1, wherein the plurality of selections of event functions from the plurality of event attendees comprises at least one of:
designations of event functions as being of interest to the plurality of event attendees; and
selection of event functions for attendance by the plurality of event attendees.

3. The method of claim 1, wherein the event is a conference.

4. The method of claim 1, wherein the information about the plurality of event attendees comprises information selected from the group of: professions, professional specialties, hobbies, professional responsibilities, job descriptions, topics of interest, lecturers of interest, geographic location of work or residence, preferences of selected named individuals, ages, genders, affiliations, nationalities, certifications, practice areas, experience level, named friends, named associates, employers, size of employers, size of businesses, academic majors, and business types.

5. The method of claim 4, wherein the information about the user comprises information selected from the group of: professions, professional specialties, hobbies, professional responsibilities, job descriptions, topics of interest, lecturers of interest, geographic location of work or residence, preferences of selected named individuals, ages, genders, affiliations, nationalities, certifications, practice areas, experience level, named friends, named associates, employers, size of employers, size of businesses, academic majors, and business types.

6. The method of claim 1, wherein the event functions suggested to the user are ranked according to frequency of selection by the plurality of event attendees having information about the plurality of event attendees similar to the information about the user.

7. The method of claim 1, wherein the event functions are presented to the user individually.

8. The method of claim 1, wherein the event functions are presented to the user in groups of event functions selected by the plurality of attendees.

9. The method of claim 1, further comprising receiving a selection of an event function from the user.

10. The method of claim 9, wherein the selection of the event function from the user comprises at least one of:
a designation of the event function as being of interest to the user; and
a selection of the event function for attendance by the user.

11. The method of claim 9, wherein the user is provided an opportunity to modify the selection of the event function.

12. The method of claim 9, wherein the information about the user and the selection of the event function from the user is used to provide suggestions of event functions to additional users.

13. A method for utilizing event attendee information during the presentation of event functions comprising:
receiving information about attendees of an event;
providing a means of identification to the attendees of the event;
using the means of identification to track attendance of the attendees of the event at sessions and exhibits of the event;
when an event attendee is tracked as attending a session or exhibit of the event, performing at least one of:
sending a message to an event attendee device providing information about the session;
sending a message to an exhibitor device indicating that the event attendee is in proximity to the exhibit; and
providing session interactivity through the event attendee device.

14. The method of claim 13, further comprising providing a notification to a first event attendee through a first event attendee device when a second event attendee having a second event attendee device is in proximity to the first event attendee and first event attendee device, wherein the notification is provided when comparing the information provided by the first and second attendees shows that at least some of the information provided by the first attendee and the second attendee matches.

15. The method of claim 13, wherein the means of identification and the event attendee device are a single device.

16. The method of claim 13, further comprising providing contextual information to the event attendee device from an exhibitor sponsoring the exhibit at the event.

17. A system for enhancing events comprising:
an event production back-end comprising:
information about sessions and meetings at an event;
information about event attendees; and
information about sessions and meetings at the event that have been
selected by the event attendees; and
a user interface front-end provided to the event attendees and to potential event attendees connected to the event production back-end and comprising:
social networking means for searching the information about sessions and meetings that have been selected by the event attendees; and
means for generating event content, whereby a user may generate event content at the user interface front-end that is linked to the event production back-end to make the generated event content available to the event attendees.

18. The system of claim 17, further comprising a lecturer interface front-end provided to lecturers and speakers at the event comprising:
means for generating event content, whereby a speaker or lecturer may generate event content for the production back-end;
means for transmitting the event content generated by the lecturer to the event attendees;
means for receiving input on the event content generated by the lecturer from the event attendees; and
means for modifying the event content generated by the lecturer.

19. The system of claim 17, further comprising a user identification device having near-field communications abilities, whereby the event production back-end may track the movement of an event attendee at sessions, meetings, and exhibits of the event.

20. The system of claim 19, further comprising:
an exhibitor interface front-end provided to exhibitors comprising:
social networking means for searching the information about event attendees and the information about sessions and meetings at the event; and
means for creating a watch list of sessions and event attendees of interest to the exhibitor; and
an exhibitor lead retrieval device connected to the production back-end that receives notification when event attendees on the watch list are in proximity to an exhibit provided by the exhibitor.
